(19) United States
(12) Patent Application Publication
(10) Pub. No.: US 2004/0018415 A1
(43) Pub. Date: Jan. 29, 2004

(54) Flat fuel cell assembly and connection structure thereof

(76) Inventors: Chiou-Chu Lai, Hsinchu (TW); Ku-Yen Kang, Taoyuang (TW); Ping-Yuan Hsu, Nantoa (TW); Kan-Lin Hsuch, Taipei (TW)

Correspondence Address: BIRCH STEWART KOLASCH & BIRCH, PO BOX 747, FALLS CHURCH, VA, 22040-0747, US

(21) Appl. No.: 10/348,175

(22) Filed: Jan. 22, 2003

(30) Foreign Application Priority Data
Jul. 25, 2002 (TW) 91116548

(51) Int. Cl. H01M 4/86

(52) U.S. Cl. 429/40

(57) ABSTRACT

A flat fuel cell assembly for producing electric power. The flat fuel cell assembly includes an insulation frame, two anodes and two membrane cathode assemblies. The insulation frame has two openings and a connecting portion therebetween. Each of the membrane cathode assemblies consists of a cathode coated with cathode catalyst and a solid electrolyte membrane. The anodes are coated with anode catalyst. The anodes and the membrane cathode assemblies form a fuel cell unit at each opening. The fuel cell units are connected in series by a connecting electrode embedded in the connection portion, forming a flat fuel cell assembly.

### BACKGROUND OF THE INVENTION

1. Field of the Invention

The present invention relates to a flat fuel cell assembly, and in particular to a flat fuel cell assembly with improved electrode structure to simplify the fabrication process.

2. Description of the Related Art

Fuel cells (FC) direct convert the chemical energy of hydrogen and oxygen to electricity. Compared to conventional power generation devices, fuel cells produce less pollution and noise, and have higher energy density and energy conversion efficiency. Fuel cells provide clean energy, and can be used in portable electronic devices, transportation, military equipments, power generating systems or the space industry, among many other applications.

Different fuel cells use different operating principles. Direct methanol fuel cells (DMFC), for example, use, on the anode side, methanol solution to proceed oxidation, producing hydrogen ions (H⁺), or protons, electrons (e⁻) and carbon dioxide (CO₂). The resulting hydrogen ions diffuse through an electrolyte toward the opposing cathode. Meanwhile, oxygen is fed to the cathode. As the proton and oxygen are combined on the cathode side, water is formed. The voltage between electrodes causes electrons flowing from the anode to the cathode sides via an external loading. The net result is that the DMFC uses methanol to produce electricity, with water and carbon dioxide as by-products.

The output voltage of a single cell is too low to drive any electronic devices. Several fuel cells must be connected in series as a fuel cell stack to provide sufficient output voltage. Conventional fuel cell assemblies comprise stacked and plane configurations. FIG. 1 shows a conventional stacked fuel cell assembly, including two end plates 11, membrane electrode assemblies 12 and a bipolar plate 13. Each membrane electrode assembly 12 includes an anode 121, a proton exchange membrane 122 and a cathode 123. The bipolar plate 13 electrically connects two membrane electrode assemblies 12 and provides passages 131 for fuel and oxygen.

The best material for bipolar plate 13 of the stacked fuel cell assembly 10 is graphite. Graphite is, unfortunately, expensive and difficult to fabricate. Moreover, the conventional fuel cell stack also requires supplementary fuel-providing, oxygen-pressurizing, temperature, and heat exchanging devices, as well as other fuel recycling devices, all of which increase production costs and limit deployment options.

FIG. 2A shows a conventional plane fuel cell assembly, and FIG. 2B is a cross section of the membrane electrode assembly in FIG. 2A. The conventional plane fuel cell assembly 20 is formed by an membrane electrode assembly 22 sandwiched between two current collecting plates 21. The current collecting plates 21 have metal meshes 211 to conduct electrons. The membrane electrode assembly 22 consists of anodes 221, cathodes 223 and a proton exchange membrane 222. The anodes 221 are arranged on the same surface of the proton exchange membrane 222, and the cathodes 223 are arranged on the other, forming several fuel cell units. The fuel cell units are connected in series by the predetermined circuit on the current collecting plates 21.

There are problems with the electrode arrangement of the conventional plane fuel cell assembly. The series current conducting path is too long, and contact between the meshes 211 and anodes/cathodes has high contact resistance. Thus, the resistance of the system becomes larger, and efficiency is lowered.

Presently, the anodes 221, the proton exchange membrane 222, and the cathodes 223 are combined by a hot pressing process to shorten the proton diffusion path and increase system efficiency. During hot press process, the anode 221 and cathode 223 of each planar fuel cell must be precisely aligned on both sides of the proton exchange membrane 222. However, this process increases the difficulty and complexity of mass production, causing high defect rate of membrane electrode assembly 22 and large amount of scrap and wasted membrane electrode assembly. The catalysts on the anodes 221 and cathodes 222 are precious metals and they are expansive. For this reason, the production cost of the conventional plane fuel cell assembly 20 is high.

### SUMMARY OF THE INVENTION

Accordingly, the first object of the invention is to provide a flat fuel cell assembly with improved electrode structure to simplify the fabrication of the membrane electrode assembly and prevent defects.

Another object of the invention is to provide a simplified electrode structure having better contact conductivity than the conventional fuel cell assembly.

The third object of the invention is to provide a manufacturing process for flat fuel cell assembly. The process is easily achieved, such that the cost of the flat fuel cell assembly of this invention can be reduced.

The present invention provides an easily fabricated flat fuel cell. The flat fuel cell comprises an insulation frame, anode, cathode and solid electrolyte membrane. The insulation frame has a first face and an opening. The anode, coated with anode catalyst, is disposed on the first surface, covering the opening. The solid electrolyte membrane covers the opening. The insulation frame, the anode and the solid electrolyte membrane form an enclosed space with electrolyte solution therein. The cathode coated with cathode catalyst is disposed on the solid electrolyte membrane opposite the anode, forming the flat fuel cell of the invention.

According to the preferred embodiment, the anode and the cathode are wire mesh of titanium, gold-plated copper, gold plated nickel or other metal.

Furthermore, the anode and the cathode of the invention are coated with a carbon particle layer. The anode catalyst and the cathode catalyst are respectively coated on the carbon particle layers of the anode and the cathode. The preferred anode catalyst is Pt/Ru alloy, and the preferred cathode catalyst is Pt.

Furthermore, the solid electrolyte membrane and the cathode are formed by hot pressing. The solid electrolyte membrane of the invention is bonded to the insulation frame by waterproof adhesive. The cathode catalyst is disposed between the solid electrolyte membrane and the cathode.

The present invention also provides another easily fabricated flat fuel cell assembly for producing electric power. The flat fuel cell assembly comprises an insulation frame, first and second anodes, first and second cathodes, first and second solid electrolyte membranes and connecting electrode. The insulation frame has a first face, a first opening, a second opening and a connecting portion between the first opening and the second opening. The first anode attaches to the first surface, covering the first opening. The second anode attaches to the first surface, covering the second opening. The first solid electrolyte membrane contacts the first opening. The insulation frame, the first anode and the first solid electrolyte membrane form a first enclosed space with electrolyte solution therein. The second solid electrolyte membrane contacts the second opening. The insulation frame, the second anode and the second solid electrolyte membrane form a second enclosed space with the electrolyte solution therein. The first cathode attaches to the first solid electrolyte membrane opposite the first anode. The second cathode attaches to the second solid electrolyte membrane opposite the second anode. The connecting electrode is embedded in the connecting portion, electrically connecting the first anode and the second cathode.

The present invention also provides another easily fabricated flat fuel cell assembly. The first anode is directly disposed on the first membrane cathode assembly, and the second anode is directly disposed on the second membrane cathode assembly, forming two electrode stacks.

According to the preferred embodiments mentioned above, the flat fuel cell assembly of the invention further comprises a first electrode and a second electrode as output terminals. The first electrode connected to the first cathode and a second electrode connected to the second anode.

Furthermore, the first and second anodes, and the first and the second cathodes are wire mesh of titanium, gold-plated copper, gold plated nickel or other metal.

Furthermore, the first and the second anodes, and the first and the second cathodes of the invention are coated with a carbon particle layer. The anode catalyst and the cathode catalyst are respectively coated on the carbon particle layers of the anodes and the cathodes. The preferred anode catalyst is Pt/Ru alloy, and the preferred cathode catalyst is Pt.

Moreover, the solid electrolyte membranes and the cathodes mentioned above are bonded by hot pressing. The first and the second solid electrolyte membranes of the invention are bonded to the insulation frame by waterproof adhesive. The cathode catalyst is disposed between each of the solid electrolyte membranes and the cathodes.

In another embodiment of the invention, the connecting electrode of the invention has an extended portion contacting the second cathode and covering the second opening opposite the second solid electrolyte membrane. The extended portion of the connecting electrode is porous. The first electrode contacts and covers the first cathode opposite the first solid electrolyte membrane. The first electrode is also porous. The connecting electrode and the first electrode are titanium or gold-plated copper. A detailed description is given in the following embodiments with reference to the accompanying drawings.

### BRIEF DESCRIPTION OF THE DRAWINGS

The present invention can be more fully understood by reading the subsequent detailed description and examples with reference made to the accompanying drawings, wherein:

FIG. 1 is an exploded view of a conventional stacked fuel cell assembly as referenced in the Prior Art;

FIG. 2A is an exploded view of a conventional plane fuel cell assembly as referenced in the Prior Art;

FIG. 2B is a cross section of the membrane electrode assembly in FIG. 2A;

FIG. 3A is a perspective view of the flat fuel cell assembly of the invention;

FIG. 3B is a perspective view with partial cross section of the flat fuel cell assembly in FIG. 3A;

FIG. 4A is a cross section of the flat fuel cell assembly of the first embodiment of the invention;

FIG. 4B is a cross section of the flat fuel cell assembly of the second embodiment of the invention;

FIG. 5A is a cross section of the flat fuel cell assembly of the third embodiment of the invention;

FIG. 5B is a cross section of the flat fuel cell assembly of the fourth embodiment of the invention;

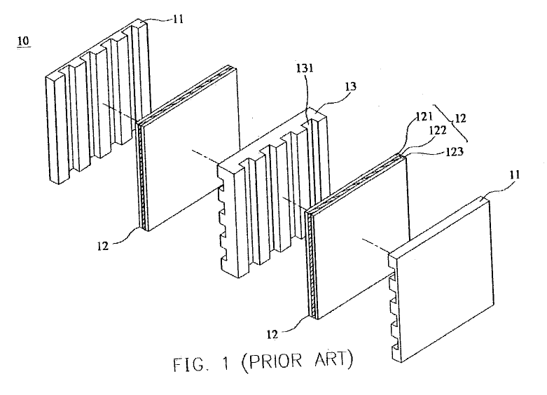

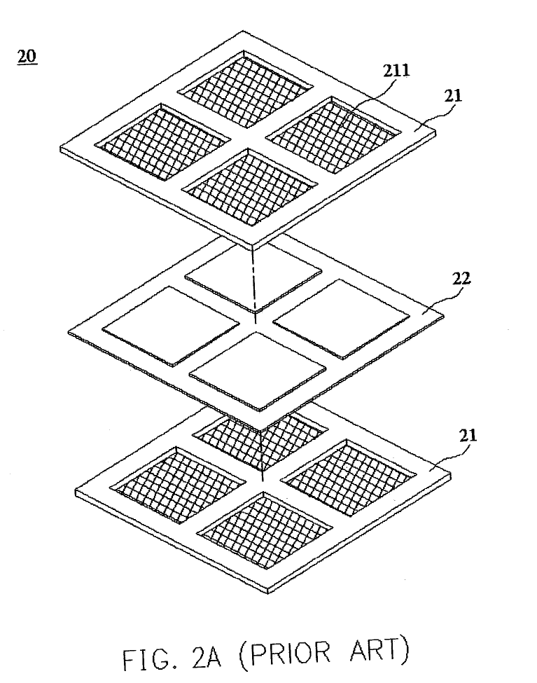

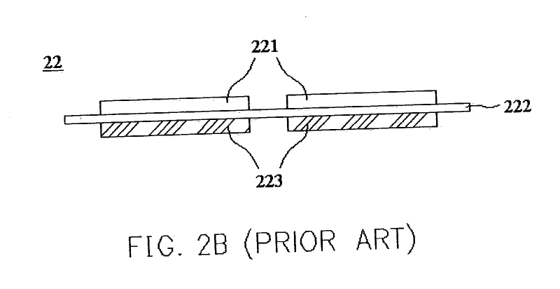

### DETAILED DESCRIPTION OF THE INVENTION

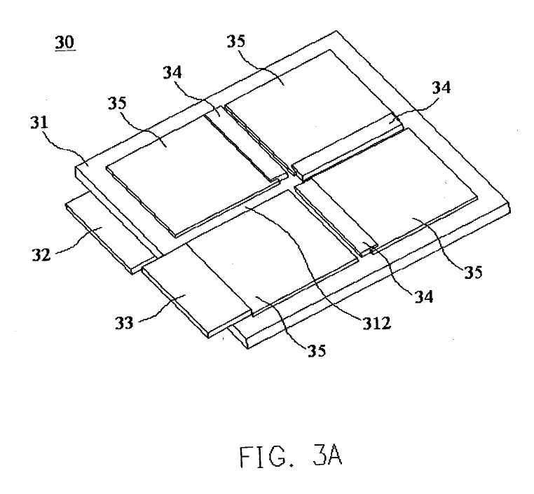

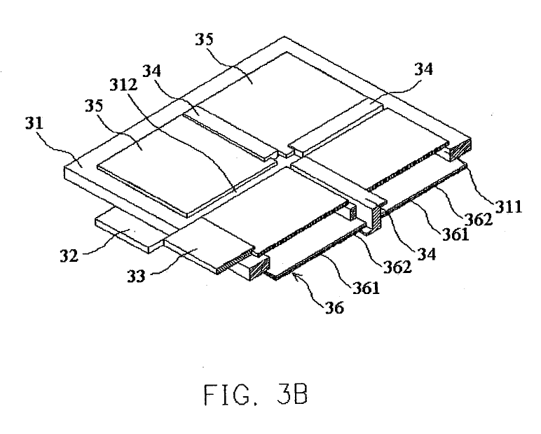

FIG. 3A shows the flat fuel cell assembly of the invention, and FIG. 3B shows its cross section. In order to simplify the drawing, the flat fuel cell assembly in FIGS. 3A and 3B only shows four fuel cell units connected in series. However, this invention includes but not limits to four cells.

In FIGS. 3A and 3B, the flat fuel cell assembly 30 has an insulation frame 31 with four openings 311 to arrange four fuel cell units. Each of the fuel cell unit includes an anode 35, cathode 361 and a solid electrolyte membrane 362 disposed between the anode 35 and the cathode 361. The cathode 361 and the solid electrolyte membrane 362 are combined by hot pressing, forming a membrane cathode assembly 36. Referring to FIG. 3B, each two neighboring fuel cell units are connected in series by a connecting electrode 34 embedded in the connection portion 312, or the cross portion, of the insulation frame 31. The anode 35 of a fuel cell unit is electrically connected to the cathode 361 of the neighboring one. The flat fuel cell assembly 30 further comprises a first electrode 32 connected to the cathode 361 of the first fuel cell unit, and a second electrode 33 connected to the anode 35 of the last fuel cell unit. The first and the second electrodes are respectively the positive and negative terminals of the fuel cell assembly 30 of the invention.

According to experimental data of a DMFC with this electrode structure, the output voltage of a fuel cell unit is about 0.2V under a fixed load of 27Ω. The output voltage of a conventional fuel cell unit under the same load is about 0.21 V. The voltage drop is only about 5%. That is, the split electrode structure does not reduce efficiency in DMFCs or other liquid solution fuel cells.

In FIG. 3B, the anodes 35 of the invention are separated from the membrane cathode assembly 36, rather than combined as in conventional plane fuel cell assembly. The anodes 35 are disposed on a surface of the insulation frame 31, covering the openings 311. The anodes 35 are coated with anode catalyst to catalyze internal fuel cell reactions, producing protons (H⁺) and electrons (e⁻) on the surface of the anodes 35. The solid electrolyte membranes 362 cover the openings on the other surface of the insulation frame 31. The solid electrolyte membrane 362 of the invention is glued to the insulation frame 31 by waterproof adhesive, such as epoxy resin, to keep the provided liquid fuel on the anode side from the cathodes 361. The cathodes 361 must continuously contact the introduced oxygen to proceed the reaction. Additionally, the insulation frame 31, the anode 35 and the solid electrolyte membrane 362 of each fuel cell unit form an enclosed space with electrolyte solution therein to deliver protons produced by the anode 35. The cathode 361 coated with cathode catalyst is disposed on the solid electrolyte membrane 362 opposite the anode 35 to form water by hydrogen ions, electrons, and the fed oxygen.

The insulation frame 31 is made by injection molding, of PC, PE or other polymer materials. The anodes 35 and the cathodes 361 are wire mesh of titanium, gold-plated copper, gold plated nickel or other gold-plated metal. The preferred anode catalyst coated on the anodes 35 is Platinum/Ruthenium (Pt/Ru) alloy, and the preferred cathode catalyst coated on the cathodes 361 is Platinum (Pt). The solid electrolyte membrane 362 is Nafion® from DuPont. The solid electrolyte membrane 362 and the cathode 361 are hot pressed at 130 degrees centigrade to form the membrane cathode assembly 36.

Furthermore, the anodes 35 and the cathodes 361 of the invention are coated with a carbon particle layer to increase the reacting surface area. The anode catalyst and the cathode catalyst are respectively coated on the carbon particle layers of the anodes 35 and the cathodes 361.

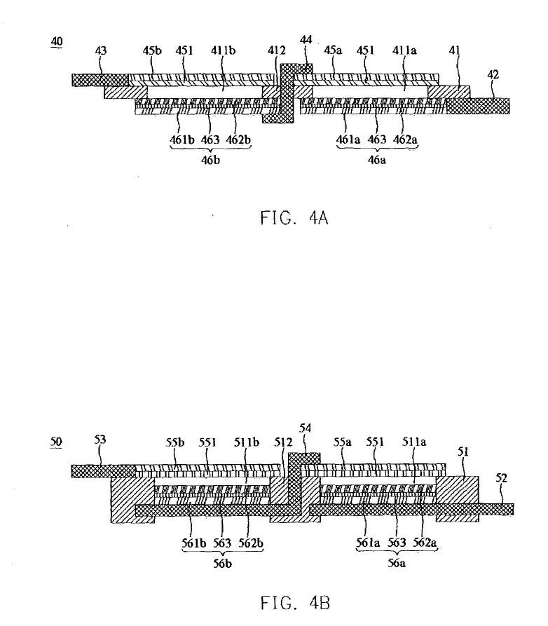

In order to simplify the drawing, each of FIGS. 4A˜5B only shows two fuel cell units connected in series to explain the structure of the invention.

First embodiment

FIG. 4A shows a cross section of the flat fuel cell assembly of the first embodiment. In FIG. 4A, the insulation frame 41 has two openings and a connecting portion 412 therebetween. The first anode 45a and the second anode 45b coated with an anode catalyst layer 451 are disposed on the top surface of the insulation frame 41, covering the openings. The first solid electrolyte membrane 462a and the first cathode 461a are bonded together by hot pressing, and the second solid electrolyte membrane 462b and the second cathode 461b are bonded together as well. The cathode catalyst layer 463 is located between each of the cathodes 461a, 461b and the solid electrolyte membranes 462a, 462b. The first solid electrolyte membrane 462a is glued to the bottom surface, covering the right opening of the insulation frame 41, such that the insulation frame 41, the first anode 45a and the first solid electrolyte membrane 462a form a first enclosed space 411a. Similarly, the second solid electrolyte membrane 462b is glued to the bottom surface, covering the left opening of the insulation frame 41, such that the insulation frame 41, the second anode 45b and the second solid electrolyte membrane 462b form a second enclosed space 411b. These two enclosed spaces are filled with electrolyte solution to diffuse hydrogen ions.

A connecting electrode 44 is embedded in the connecting portion 412, contacting the first anode 45a and the second cathode 461b to connect the two fuel cell units in series. The flat fuel cell assembly 40 of the invention further comprises a first electrode 42 electrically connected to the first cathode 461 and a second electrode 43 electrically connected to the second anode 45b. The first and second electrodes 42, 43 are the negative and the positive electrodes of this flat fuel cell assembly. The electrodes can be connected by welding, soldering, mechanic pressing or conductive adhesive. Moreover, there must be an additional container (not shown) in which to store liquid fuel at the anode side to proceed the oxidation reaction.

Second embodiment

FIG. 4B shows another cross section of the flat fuel cell assembly of the invention. The basic structures of the flat fuel cell assemblies shown in FIGS. 4A and 4B are the same. The differences are the shapes of the connecting electrode 54. The connecting electrode 54 has an extended portion 541 contacting the bottom surface of the second cathode 561b and covering the second opening. The extended portion 541 of the connecting electrode 54 is porous, such that oxygen can pass through, contacting the second cathode 561b. As well, the first electrode 52 contacts and covers the bottom surface of the first cathode 561a. The first electrode 52, or at least the portion covering the first cathode 561a, is porous. The connecting electrode 54, the first and the second electrodes 52, 53 are titanium, gold-plated copper, gold-planted nickel or other gold plated metals.

Third Embodiment

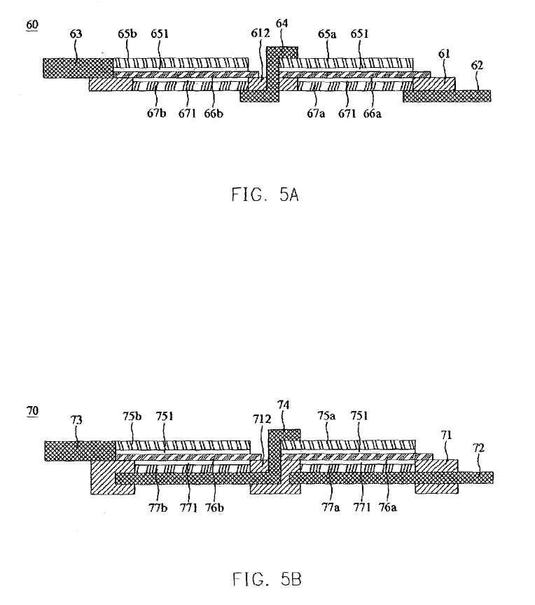

FIG. 5A shows another structure of the flat fuel cell assembly of the invention. In FIG. 5A, the insulation frame 61 has two openings and a connecting portion 612 therebetween. The first and the second solid electrolyte membranes 66a, 66b are glued to the top surface of the insulation frame 61, covering the openings, using waterproof adhesive. The first cathode 67a is disposed in the right opening, attached to the bottom surface of the first solid electrolyte membrane 66a, and the second cathode 67b is disposed in the left opening, attached to the bottom surface of the second solid electrolyte membrane 66b. The cathode catalyst layer is sandwiched between each of the cathodes 67a, 67b and the solid electrolyte membranes 66a, 66b. As well, the first anode 65a is disposed on the top surface of the first solid electrolyte membrane 66a, and the second anode 65b is disposed on the top surface of the second solid electrolyte membrane 66b. The anode catalyst layer 651 is located between each of the anodes 65a, 65b and the solid electrolyte membranes 66a, 66b.

Furthermore, a connecting electrode 64 is embedded in the connecting portion 612, contacting the first anode 65a and the second cathode 67b to connect these two fuel cell units in series. The flat fuel cell assembly 60 of the invention further comprises a first electrode 62 electrically connected to the first cathode 67a and a second electrode 63 electrically connected to the second anode 65b. The first and second electrodes 62, 63 are the negative and the positive of this flat fuel cell assembly 60. The electrodes can be connected by welding, soldering, mechanic pressing, or conductive adhesive. Moreover, there must be an additional container (not shown) in which to store liquid fuel at the anode side to proceed the oxidation reaction.

Compared to the flat fuel cell assembly shown in FIG. 4A, the anode, the first anode 65a of the third embodiment (FIG. 5A) is directly disposed on the first membrane cathode assembly 66a, and the second anode 65b is directly disposed on the second membrane cathode assembly 66b, forming two electrode stacks. The structure shown in FIG. 5A can be thinner than the structures shown in the FIGS. 4A˜4B. The structure of this embodiment can only be used in DMFCs or the other liquid solution fuel cells. Otherwise, if the anode, the solid electrolyte membrane and the cathode are combined by hot pressing, forming membrane electrode assembly, the fuel cell stack can be used in the conventional hydrogen fuel cell.

Fourth embodiment

FIG. 5B shows another flat fuel cell assembly modified from the structure of the third embodiment. The differences are the shapes of the connecting electrode 74. The connecting electrode 74 has an extended portion 741 contacting the bottom surface of the second cathode 77b and covering the second opening. The extended portion 741 of the connecting electrode is porous, such that oxygen can pass through, reaching the second cathode 77b. As well, the first electrode 72 contacts and covers the bottom surface of the first cathode 77a. The first electrode 72, or only the portion covering the first cathode 77a, is porous. The connecting electrode 74, the first and the second electrodes 72, 73 are titanium, gold-plated copper, gold-planted nickel or other gold plated metals.

According to the flat fuel cell assemblies of the invention, the anodes are separated from conventional membrane electrode assemblies to simplify the conventional bonding process. The improved electrode connecting structure raises the system efficiency. Thus, the production cost of the flat fuel cell assembly of the invention is reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flat fuel cell for producing electric power by liquid fuel, comprising:
an insulation frame, having a first face and an opening;
an anode, coated with anode catalyst and disposed on the first surface, covering the opening;
a solid electrolyte membrane, contacting the opening, wherein the insulation frame, the anode and the solid electrolyte membrane form an enclosed space with electrolyte solution therein;
a cathode, coated with cathode catalyst and disposed on the solid electrolyte membrane opposite the anode.

2. The flat fuel cell as claimed in claim 1, wherein the anode and the cathode are metal meshes.

3. The flat fuel cell as claimed in claim 2, wherein the metal meshes are titanium.

4. The flat fuel cell as claimed in claim 2, wherein the metal meshes are gold-plated nickel.

5. The flat fuel cell as claimed in claim 1, wherein the anode and the cathode are coated with a carbon particle layer, and the anode catalyst and the cathode catalyst are respectively coated on the carbon particle layers.

6. The flat fuel cell as claimed in claim 1, wherein the anode catalyst is Platinum/Ruthenium alloy.

7. The flat fuel cell as claimed in claim 1, wherein the cathode catalyst is platinum (Pt).

8. The flat fuel cell as claimed in claim 1, wherein the solid electrolyte membrane is bonded to the insulation frame by waterproof adhesive.

9. The flat fuel cell as claimed in claim 1, wherein the solid electrolyte membrane and the cathode are bonded by hot pressing.

10. The flat fuel cell as claimed in claim 1, wherein the cathode catalyst is disposed between the solid electrolyte membrane and the cathode.

11. A flat fuel cell assembly for producing electric power by liquid fuel, comprising:
an insulation frame, having a first face, a first opening, a second opening and a connecting portion between the first opening and the second opening;
a first anode, disposed on the first face and covering the first opening;
a second anode, disposed on the first face and covering the second opening, wherein the first anode and the second anode are coated with anode catalyst;
a first solid electrolyte membrane, contacting the first opening, wherein the insulation frame, the first anode and the first solid electrolyte membrane form a first enclosed space with electrolyte solution therein;
a second solid electrolyte membrane, contacting the second opening, wherein the insulation frame, the second anode and the second solid electrolyte membrane form a second enclosed space with the electrolyte solution therein;
a first cathode, disposed on the first solid electrolyte membrane opposite the first anode;
a second cathode, disposed on the second solid electrolyte membrane opposite the second anode, wherein the first cathode and the second cathode are coated with cathode catalyst; and
a connecting electrode, embedded in the connecting portion and electrically connecting the first anode and the second cathode.

12. The flat fuel cell assembly as claimed in claim 11, further comprising:
a first electrode, electrically connected to the first cathode; and
a second electrode, electrically connected to the second anode.

13. The flat fuel cell assembly as claimed in claim 11, wherein the first anode, the second anode, the first cathode and the second cathode are metal meshes.

14. The flat fuel cell assembly as claimed in claim 13, wherein the metal meshes are titanium.

15. The flat fuel cell assembly as claimed in claim 13, wherein the metal meshes are gold-plated nickel.

16. The flat fuel cell assembly as claimed in claim 11, wherein the first anode, the second anode, the first cathode and the second cathode are coated with a carbon particle layer, and the anode catalyst and the cathode catalyst are respectively coated on the carbon particle layers.

17. The flat fuel cell assembly as claimed in claim 11, wherein the anode catalyst is Platinum/Ruthenium alloy.

18. The flat fuel cell assembly as claimed in claim 11, wherein the cathode catalyst is platinum (Pt).

19. The flat fuel cell assembly as claimed in claim 11, wherein the first solid electrolyte membrane and the second solid electrolyte membrane are bonded to the insulation frame by waterproof adhesive.

20. The flat fuel cell assembly as claimed in claim 11, wherein the first solid electrolyte membrane and the first cathode are bonded by hot pressing, and the second solid electrolyte membrane and the second cathode are bonded by hot pressing.

21. The flat fuel cell assembly as claimed in claim 11, wherein the cathode catalyst is disposed between the first solid electrolyte membrane and the first cathode, and between the second solid electrolyte membrane and the second cathode.

22. The flat fuel cell assembly as claimed in claim 11, wherein the connecting electrode has an extended portion contacting the second cathode and covering the second opening opposite the second solid electrolyte membrane.

23. The flat fuel cell assembly as claimed in claim 22, wherein the extended portion of the connecting electrode is porous.

24. The flat fuel cell assembly as claimed in claim 11, wherein the connecting electrode is titanium.

25. The flat fuel cell assembly as claimed in claim 11, wherein the connecting electrode is gold-plated nickel.

26. The flat fuel cell assembly as claimed in claim 12, wherein the first electrode contacts and covers the first cathode opposite the first solid electrolyte membrane.

27. The flat fuel cell assembly as claimed in claim 26, wherein the first electrode is porous.

28. The flat fuel cell assembly as claimed in claim 26, wherein the first electrode and the second electrode are titanium.

29. A flat fuel cell assembly for producing electric power by liquid fuel, comprising:
an insulation frame, having a first face, a first opening, a second opening and a connecting portion between the first opening and the second opening;
a first solid electrolyte membrane, disposed on the first face and covering the first opening;
a second solid electrolyte membrane, disposed on the first face and covering the second opening;
a first cathode, attached to the first solid electrolyte membrane and disposed within the first opening;
a second cathode, attached to the second solid electrolyte membrane and disposed within the second opening, wherein the first cathode and the second cathode are coated with cathode catalyst;
a first anode, attached to the first solid electrolyte membrane opposite the first cathode;
a second anode, attached to the second solid electrolyte membrane opposite the second cathode, wherein the first anode and the second anode are coated with anode catalyst; and
a connecting electrode, embedded in the connecting portion and electrically connecting the first anode and the second cathode.

30. The flat fuel cell assembly as claimed in claim 29, further comprising:
a first electrode, electrically connected to the first cathode; and
a second electrode, electrically connected to the second anode.

31. The flat fuel cell assembly as claimed in claim 29, wherein the first anode, the second anode, the first cathode and the second cathode are metal meshes.

32. The flat fuel cell assembly as claimed in claim 31, wherein the metal meshes are titanium.

33. The flat fuel cell assembly as claimed in claim 31, wherein the metal meshes are gold-plated nickel.

34. The flat fuel cell assembly as claimed in claim 29, wherein the first anode, the second anode, the first cathode and the second cathode are coated with a carbon particle layer, and the anode catalyst and the cathode catalyst are respectively coated on the carbon particle layers.

35. The flat fuel cell assembly as claimed in claim 29, wherein the anode catalyst is Platinum/Ruthenium alloy.

36. The flat fuel cell assembly as claimed in claim 29, wherein the cathode catalyst is platinum (Pt).

37. The flat fuel cell assembly as claimed in claim 29, wherein the first solid electrolyte membrane and the second solid electrolyte membrane are bonded to the insulation frame by waterproof adhesive.

38. The flat fuel cell assembly as claimed in claim 29, wherein the first solid electrolyte membrane and the first cathode are bonded by hot pressing, and the second solid electrolyte membrane and the second cathode are bonded by hot pressing.

39. The flat fuel cell assembly as claimed in claim 29, wherein the cathode catalyst is disposed between the first solid electrolyte membrane and the first cathode, and between the second solid electrolyte membrane and the second cathode.

40. The flat fuel cell assembly as claimed in claim 29, wherein the connecting electrode has an extended portion contacting the second cathode and covering the second opening opposite the second solid electrolyte membrane.

41. The flat fuel cell assembly as claimed in claim 40, wherein the extended portion of the connecting electrode is porous.

42. The flat fuel cell assembly as claimed in claim 29, wherein the connecting electrode is titanium.

43. The flat fuel cell assembly as claimed in claim 29, wherein the connecting electrode is gold-plated nickel.

44. The flat fuel cell assembly as claimed in claim 30, wherein the first electrode contacts and covers the first cathode opposite the first solid electrolyte membrane.

45. The flat fuel cell assembly as claimed in claim 44, wherein the first electrode is porous.

46. The flat fuel cell assembly as claimed in claim 44, wherein the first electrode and the second electrode are titanium.
